(19) United States
(12) Patent Application Publication
(10) Pub. No.: US 2006/0223904 A1
(43) Pub. Date: Oct. 5, 2006

(54) Adhesive composition and optical disc prepared therewith

(76) Inventors: Go Mizutani, Kita-ku (JP); Kiyohisa Tokuda, Kita-ku (JP); Kazuhiko Ishii, Kita-ku (JP); Masahiro Naitoh, Kita-ku (JP); Takeo Miyake, Fukuyama-shi (JP)

Correspondence Address: NIELDS & LEMACK, 176 EAST MAIN STREET, SUITE 7, WESTBORO, MA, 01581, US

(21) Appl. No.: 10/567,294

(22) PCT Filed: Aug. 11, 2004
(86) PCT No.: PCT/JP04/11545

§ 371 Date: Apr. 10, 2006

(30) Foreign Application Priority Data
Aug. 12, 2003 (JP) 2003-292067

(51) Int. Cl. C08F 290/00; C08F 2/46

(52) U.S. Cl. 522/92; 522/90; 522/96; 522/100; 522/103

(57) ABSTRACT

The present invention provides an adhesive composition (a UV-curable resin composition) comprising a bisphenol type epoxy(meth)acrylate (A), a di(meth)acrylate compound (B) having a cyclic ether structure, and a photo-polymerization initiator (C), and a bonded optical disk which is adhered with a cured product of said adhesive composition. By adhering with said composition optical disk substrates having a translucent reflection film or a total reflection film comprising silver, a silver alloy, or the like, and obtaining a bonded optical disk, high durability equivalent to those of conventional bonded optical disks in which a translucent reflection film of gold is used, and high adhesion strength between a reflection film and an adhesive cured product, and a polycarbonate substrate and an adhesive cured product, can be obtained.

### TECHNICAL FIELD

The present invention relates to an adhesive composition comprising a UV-curable adhesive composition suitable for bonding an optical disk substrate, and especially it is useful for adhering two optical disk substrates which are used for DVDs. The present invention relates also to an optical disk bonded with said adhesive composition.

### BACKGROUND ART

DVDs in practical use at present can be roughly classified into DVD-ROMs on which information such as movies has been recorded when producing the disk, and blank DVDs on which no information is recorded upon production allowing consumers themselves to record information on a pigment recording layer or an inorganic recording layer. As to DVD-ROMs, information is recorded on the substrates thereof, and they have types as follows. They include DVD-5 with a structure of single-sided read and single recording layer having a recording capacity of about 5 GB, DVD-9 of a single-sided read and dual recording layer having a recording capacity of about 9 GB, DVD-10 of a double-sided read and dual recording layer having a recording capacity of about 10 GB, and DVD-18 of a double-sided read and quadruple recording layer having a recording capacity of about 18 GB. At present, DVD-9s are most commonly used because of their recording capacity for recording a movie of about two and a half hours. DVD-9s use a total reflection film and a translucent reflection film since it is a type of a single-sided read and dual recording layer, and those using an aluminum alloy as a total reflection film and gold as a translucent reflection film are most common. Unlike a total reflection film, a translucent reflection film must transmit laser, and so the film needs to be thin. Thus, gold, which can be easily formed into a thin film and is relatively stable, has been conventionally used.

Gold, however, is very expensive and therefore the material for a translucent reflection film has been shifted from gold to silicon or a silicon compound, and further to silver or a silver alloy. In addition, use of blue lasers is now being developed for further increase of recording capacity. Optical disks of using conventional red lasers do not have any problem of laser transmittance even if a material for the translucent reflection film is gold, silicon, a silicon compound, silver or a silver alloy, and on the contrary for blue lasers, their wavelengths reside in the vicinity of about 400 nm, and therefore a material for a translucent reflection film, which has good transmittance of light having said wavelengths is limited to silver or a silver alloy. However, these have a disadvantage that they are more susceptible to oxidation and unstable than gold. When an optical disk wherein a thin film of silver or a silver alloy is used for a translucent reflection film is allowed to adhere with a conventional resin composition for a bonded optical disk, durability equivalent to those of bonded optical disks in which conventional gold is used as a material for the translucent reflection film, cannot be obtained. Therefore, an adhesive composition having satisfactory durability is requested to provide.

On the other hand, in the field of blank DVDs, there are various formats including DVD−R, DVD+R,. DVD−RW, DVD+RW, and DVD-RAM. Presently dominant DVD−R, DVD-RAM, DVD+R and DVD+RW are of single-sided, single layer structure, and those bonded with a polycarbonate substrate and a substrate provided with a recording layer and a reflection film layer, are used. As a material for a reflection film layer, silver or a silver alloy, which has high reflectance, is used in a thickness to some extent (for example, 10 to 200 nm). Among new formats, there is a type having two layers of a translucent reflection film layer and a total reflection film layer, wherein silver or a silver alloy having high reflectance is used as a material for a reflection film layer. However, because silver or a silver alloy is subject to oxidation, a protective coat must be formed. Whereas formation of the protective coat can achieve high durability, it has involved problems such as decrease of production efficiency of optical disks, increase of production cost and decrease of production yield. Development of an adhesive resin composition, which can afford equivalent durability without forming a protective coat, has been desired.

Patent literature 1 describes a UV-curable adhesive composition suitable for an optical disk, having as a main component a (meth)acrylate having an alicyclic structure, and it is shown that durability in chemical change is improved such as oxidizing in a bonded optical disk using a translucent reflection film layer such as of silver or a silver alloy. However, in a UV-curable adhesive composition suitable for an optical disk, having as a main component a (meth)acrylate having an alicyclic structure, there has been a problem that adhesion between said translucent reflection film and/or total reflection film and an adhesive cured product is weak.

Patent literature 1: JP-A-2001-167478

### DISCLOSURE OF THE INVENTION

### PROBLEMS TO BE SOLVED BY THE INVENTION

The present invention aims at providing a resin composition for an adhesive, which affords, in a bonded optical disk having a total reflection film or a translucent reflection film comprising silver, a silver alloy, or the like, high durability equivalent to those of conventional optical disks in which gold is used for a translucent reflection film, and further has excellent adhesion between both of a reflection film and a polycarbonate substrate, and an adhesive layer (an adhesive cured product).

### MEANS FOR SOLVING THE PROBLEMS

The present inventors have conducted intensive studies to solve the above-mentioned problems and as a result, have found an adhesive composition having excellent durability and adhesion even in a bonded optical disk having a total reflection film or a translucent reflection film comprising silver, a silver alloy, or the like, and thus have accomplished the present invention.

Accordingly, the present invention relates to:
(1) An adhesive composition comprising a bisphenol type epoxy(meth)acrylate (A), a di(meth)acrylate compound (B) having a cyclic ether structure, and a photo-polymerization initiator (C);
(2) The adhesive composition according to the above-described (1), which further comprises a (meth)acrylate phosphate compound (D);
(3) The adhesive composition according to the above-described (1), which further comprises a urethane(meth)acrylate (E);
(4) The adhesive composition according to the above-described (1), which comprises a bisphenol type epoxy(meth)acrylate (A), a di(meth)acrylate compound (B) having a cyclic ether structure, a photo-polymerization initiator (C), a (meth)acrylate phosphate compound (D), and a urethane(meth)acrylate (E);
(5) The adhesive composition according to the above-described (1), which comprises, in terms of % by weight based on the total of the adhesive composition, 1 to 70% of a bisphenol type epoxy(meth)acrylate (A), 5 to 75% of a di(meth)acrylate compound (B) having a cyclic ether structure, 0.05 to 20% of a photo-polymerization initiator (C), and a residue of another component;
(6) The adhesive composition according to the above-described (1), wherein the di(meth)acrylate compound (B) having a cyclic ether structure is trimethylolpropane di(meth)acrylate modified with a tertiary aldehyde having a carbon number of 4 to 10 which may have hydroxy-substitution;
(7) The adhesive composition according to the above-described (6), wherein the di(meth)acrylate compound (B) having a cyclic ether structure is a hydroxypivalic aldehyde modified trimethylolpropane di(meth)acrylate;
(8) A bonded optical disk, wherein two optical disk substrates are adhered with a cured product of an adhesive composition according to any one of the above-described (1) to (7); and
(9) The bonded optical disk according to the above-described (8), wherein at least one of the optical disk substrates is an optical disk substrate having a total reflection film or a translucent reflection film comprising silver or a silver alloy.

### EFFECT OF THE INVENTION

By adhering optical disk substrates using a composition (a UV-curable resin composition) according to the present invention, in a bonded optical disk using a translucent reflection film or a total reflection film of silver or a silver alloy, high durability equivalent to those of conventional bonded optical disks in which gold is used for a translucent reflection film, can be obtained and further high adhesive strength between a translucent reflection film or a total reflection film and an adhesive cured product can be obtained. Moreover, among blank DVDs such as DVD−R, DVD+R, DVD−RW, DVD+RW, DVD-RAM, and the like, in blank DVDs wherein silver or a silver alloy is used as a reflection film, high durability equivalent to that on use of a protective coat can be obtained, and further high adhesion strength between a metallic reflection film and an adhesive cured product, and a polycarbonate substrate and an adhesive cured product, can be obtained. Due to high adhesion strength, even by repeating use of DVDs, a bonded optical disk cannot be peeled.

### BEST MODE OF EMBODIMENT TO CONDUCT THE INVENTION

An adhesive composition according to the present invention is suitable for bonding an optical disk, and is a UV-curable resin composition which can be cured usually by light, especially by UV. Therefore, hereinafter an adhesive composition according to the present invention is sometimes described as a UV-curable resin composition according to the present invention. Said composition is characterized by containing at least three of a bisphenol type epoxy(meth)acrylate (A), a di(meth)acrylate compound (B) having a cyclic ether structure, and a photo-polymerization initiator (C). In this connection, in the present invention, “a (meth)acrylate”, “a (meth)acrylic acid”, and the like used in a bisphenol type epoxy(meth)acrylate, (meth)acrylic acid, or the like, each means either one or both of a methacrylate and an acrylate, or of a methacrylic acid and an acrylic acid.

In the present invention, a bisphenol type epoxy(meth)acrylate (A) has a function to improve a curing rate or to improve hardness of a cured product.

As a bisphenol type epoxy(meth)acrylate (A) contained in the composition according to the present invention, an epoxy(meth)acrylate obtained by a reaction of a bisphenol type epoxy resin, or the like, and a (meth)acrylic acid, for instance, by a reaction described below, is exemplified. As said bisphenol type epoxy resin, any one of bisphenol type epoxy resins can be used, and a preferred one thereof includes a bisphenol A type epoxy resin (for example, Epikoat 802, 1001, 1004 (Trade name), and the like manufactured by Japan epoxy resins, Co., Ltd.), or a bisphenol F type epoxy resin (for example, Epikoat 4001P, 4002P, 4003P (Trade name), and the like manufactured by Japan epoxy resins, Co., Ltd.), and the like. A bisphenol A type epoxy resin is more preferable. In this connection, a bisphenol type epoxy resin in (A) component does not include a modified product or a hydrogenated product, or the like thereof, and said modified product or hydrogenated product, or the like is contained in (B-1) component described below.

A preferable bisphenol type epoxy(meth)acrylate (A) can be obtained as follows.

A bisphenol type epoxy resin, or the like and a (meth)acrylic acid are reacted in a ratio of 0.9 to 1.5 moles, more preferably 0.95 to 1.1 moles, of (meth)acrylic acid based on 1 equivalent of epoxy group of the bisphenol type epoxy resin (a glycidyl ether type epoxy compound). A reaction temperature is preferably 80 to 120° C., and a reaction time is about 10 to 35 hours. To facilitate the reaction, a catalyst such as triphenylphosphine, triethanolamine, tetraethylammonium chloride, or the like is preferably used. In addition, to prevent a polymerization during the reaction, a polymerization inhibitor (e.g. paramethoxyphenol, methylhydroquinone, or the like) may be used.

The bisphenol type epoxy(meth)acrylate (A) may be used in an optional ratio of alone or a mixture of two sorts or more. A content of the bisphenol type epoxy(meth)acrylate (A) is usually 1 to 70% by weight, and preferably 5 to 40% by weight, more preferably 10 to 40% by weight based on the total weight of the composition according to the present invention. A molecular weight of the bisphenol type epoxy(meth)acrylate (A) is preferably 500 to 10000.

A di(meth)acrylate compound (B) having a cyclic ether structure contained in the composition according to the present invention is, for example, a di(meth)acrylate having an alicyclic partial structure containing 1 to a plural number, preferably 1 to 4, more preferably 1 to 2, of an oxygen atom, and is a di(meth)acrylate containing acyclic ether structure of, preferably a 3 to 8 members ring, more preferably a 5 to 6 members ring. Said di(meth)acrylate, due to effect of a position of a cyclic ether has a function of enhancing adhesion between a metallic reflection film of such as silver, a silver alloy, aluminum, or the like and an adhesive cured product, and a polycarbonate substrate and an adhesive cured product, can be obtained.

The di(meth)acrylate compound (B) having a cyclic ether structure includes a hydroxy-substituted (C4 to C10) tertiary aldehyde modified trimethylolpropane di(meth)acrylate or a modified product thereof, specifically a hydroxypivalic aldehyde modified trimethylolpropane di(meth)acrylate (for example, KAYARAD R-604 manufactured by NIPPON KAYAKU Co., Ltd.) or a modified product thereof (for example, a caprolactone modified hydroxypivalic aldehyde modified trimethylolpropane di(meth)acrylate, or the like), spiro-glycol di(meth)acrylate, or the like. Preferably, it is a hydroxypivalic aldehyde modified trimethylolpropane di(meth)acrylate.

The (B) component can be used in an optional proportion of alone or a mixture of at least two sorts thereof. A content of (B) component is usually 5 to 75% by weight (hereinafter % represents % by weight unless noted otherwise), preferably 10 to 60% or 70%, more preferably 35 to 65%, based on the total weight of the composition according to the present invention.

In the UV-curable resin composition according to the present invention, a (meth)acrylate monomer (B-1) excluding the above-described (B) component, (D) component and (E) component described below (abbreviated as “other acrylate” depending on cases), can be added. (B-1) component includes, for example, a mono-functional or multi-functional monomer such as an ester of an alcohol having a carbon number of 1 to 15, which may have a substituent such as a hydroxyl group or an alkoxyl group, with a (meth)acrylic acid, and the like. Specifically, the mono-functional monomer includes, for example, tricyclodecane(meth)acrylate, dicyclopentadiene oxyethyl(meth)acrylate, dicyclopentanyl(meth)acrylate, isobornyl(meth)acrylate, adamantyl(meth)acrylate, phenoxyethyl(meth)acrylate, phenoxypolyethylene glycol(meth)acrylate, benzyl(meth)acrylate, tetrahydrofurfuryl(meth)acrylate, morpholine(meth)acrylate, 2-hydroxy propyl(meth)acrylate, lauryl(meth)acrylate, isodecyl(meth)acrylate, stearyl(meth)acrylate, isooctyl(meth)acrylate, tridecyl(meth)acrylate, ethoxydiethyrene glycol(meth)acrylate, and the like.

Further as (B-1) component, a multi-functional (meth)acrylate monomer which has at least two (meth) acrylate groups in the molecule thereof includes, for example, cyclohexane-1,4-dimethanol di(meth)acrylate, cyclohexane-1,3-dimethanol di(meth)acrylate, tricyclodecane-dimethylol di(meth)acrylate (for example, KAYARAD R-684 manufactured by NIPPON KAYAKU Co., Ltd., tricyclodecane-dimethylol diacrylate, and the like), a hydrogenated bisphenol A polyethoxy-di(meth)acrylate, a hydrogenated bisphenol A polypropoxy-di(meth)acrylate, a hydrogenated bisphenol F polyethoxy-di(meth)acrylate, a polyethoxy-di(meth)acrylate of cyclohexane-1,4-dimethanol, a di(meth)acrylate of an adduct with ε-caprolactone of hydrogenated bisphenol A, a di(meth)acrylate of an adduct with ε-caprolactone of cyclohexane-1,4-dimethanol, a di(meth)acrylate of hydrogenated bisphenol A diglycidyl ether, a di(meth)acrylate of hydrogenated bisphenol F diglycidyl ether, a di(meth)acrylate of hydrogenated bisphenol A diglycidyl ether, a di(meth)acrylate of hydrogenated bisphenol F diglycidyl ether, neopentyl glycol di(meth)acrylate, a polyethylene glycol di(meth)acrylate, dicyclopentanyl di(meth)acrylate, 1,6-hexanediol di(meth)acrylate, a polypropylene glycol di(meth)acrylate, an ethylene oxide modified bisphenol A di(meth)acrylate, an ethylene oxide modified trimethylol propane tri(meth)acrylate, an ethylene oxide modified pentaerythritol tetra(meth)acrylate, tris[(meth)acryloxyethyl]isocyanurate, an ethylene oxide modified dipentaerythritol hexa(meth)acrylate, and the like.

The (meth)acrylate monomer (B-1) can be used in an optional proportion of alone or a mixture of at least two sorts thereof. A content of said (meth)acrylate monomer (B-1) is usually 0 to 85%, preferably 0 to 60%, more preferably 0 to 40%, based on the total weight of the composition according to the present invention. Depending on cases, 10 to 60% is preferred.

As a photo-polymerization initiator (C) contained in the composition according to the present invention, 1-hydroxycyclohexyl phenyl ketone, 2,2-dimethoxy-2-phenylacetophenodroxy-2-methyl-1-phenylpropane-1-one, 1-[4-(2-hydroxyethoxy)-phenyl]-2-hydroxy-2-methyl-1-propane-1-one or 2-methyl-[4-(methylthio)phenyl]-2-morpholino-1-propane is preferable, and it can be used in an optional proportion of alone or a mixture of at least two sorts thereof. A content of the photo-polymerization initiator (C) is usually 0.5 to 20%, preferably 1 to 10%, based on the total weight of the composition according to the present invention.

Further, in the present invention, other photopolymerization initiators may be used together if necessary. As a preferable one, the following can be exemplified. For example, it includes 2-benzyl-2-dimethylamino-1-(4-morpholinophenyl)-butan-1-one, 2-chlorothioxanthone, 2,4-dimethylthioxanethone, 2,4-diisopropylthioxanthone, isopropylthioxanthone, 2,4,6-trimethylbenzoyldiphosphine oxide and bis(2,6-dimethoxy-benzoyl)-2,4,4-trimethylpentylphosphine oxide, and the like. The photopolymerization initiator may be used in an optional proportion of alone or a mixture of at least two sorts thereof. The content thereof is usually 0 to 5%, 0.005 to 5% depending on cases, and preferably 0 to 5%, 0.01 to 3% depending on cases based on the total weight of the composition according to the present invention.

In addition, amines or the like which can be a photopolymerization accelerator may also be used together with the above-described photopolymerization initiator. The amines or the like which can be used include 2-dimethylaminoethyl benzoate, dimethylaminoacetophenone, ethyl p-dimethylaminobenzoate, isoamyl p-dimethylaminobenzoate, and the like. When the photopolymerization accelerator such as said amines is used, the content thereof is usually 0 to 5%, 0.005 to 5% depending on cases, and preferably 0 to 3%, 0.01 to 3% depending on cases based on the total weight of the composition according to the present invention.

To the UV-curable resin composition according to the present invention, a (meth)acrylate phosphate compound (D) may be added if necessary. The (meth)acrylate phosphate compound (D) has a function to improve an adhesive property between aluminum, silver, or a silver alloy and an adhesive cured product, but attention is necessary to an amount to be used, since it has a fear of corroding a metallic film.

The (meth)acrylate phosphate compound (D) which can be contained in the composition according to the present invention, may be a monoester, diester, trimester or the like, and is not limitative so long as it is a (meth)acrylate having a phosphoric ester bone. For instance, a preferable one thereof includes C1 to C3 alkylene oxide modified C6 to C10 aryloxy or C1 to C10 alkoxy mono-, di-, or tri-(meth)acrylate phosphate, and for example, it includes ethylene oxide modified phenoxide(meth)acrylate phosphate, ethylene oxide modified butoxide(meth)acrylate phosphate, ethylene oxide modified octyl oxide(meth)acrylate phosphate, and C1 to C3 alkylene oxide modified mono-, di-, or tri-(meth)acrylate phosphate including ethylene oxide modified di(meth)acrylate phosphate and ethylene oxide modified tri(meth)acrylate phosphate, and the like. Among these, a C1 to C3 alkylene oxide modified mono-, di-, or tri-(meth)acrylate phosphate is preferable. C1 to C3 alkylene oxide modified mono-, di-, or tri-(meth)acrylate phosphate is more preferable. The (meth)acrylate phosphate (D) may be used in an optional proportion of alone or a mixture of at least two sorts thereof. The content of (meth)acrylatephosphate compound (D) is usually 0 to 5%, 0.005 to 5% depending on cases, and preferably 0 to 3%, 0.05 to 3% depending on cases, based on the total weight of the composition according to the present invention.

To the composition according to the present invention, a urethane(meth)acrylate (E) may be added if necessary. The urethane(meth)acrylate (E) further improves adhesion and improves flexibility of adhesive cured film as well. Therefore, by making (E) component contained, warp of bonded optical disks obtained can be made small. The urethane(meth)acrylate (E) in the present invention can be obtained by reacting a polyhydric alcohol, an organic polyisocyanate and a hydroxy(meth)acrylate compound.

The polyhydric alcohol includes, for example, a C1 to C10 alkylene glycol such as neopentyl glycol, 3-methyl-1,5-pentanediol, ethylene glycol, propylene glycol, 1,4-butanediol, and 1,6-hexanediol, an aliphatic polyol, preferably a C1 to C15, more preferably a C2 to C12 aliphatic polyol, such as trimethylolpropane, pentaerythritol, tricyclodecane dimethylol and bis-[hydroxymethyl]-cyclohexane; a polyester polyol obtained by a reaction of the polyhydric alcohol and a polybasic acid, preferably a C3 to C12 polybasic acid (e.g. a succinic acid, a phthalic acid, a hexahydrophthalic anhydride, a terephthalic acid, an adipic acid, an azelaic acid and a tetrahydrophthalic anhydride); a caprolactone alcohol obtained by a reaction of the above-described aliphatic polyol and ε-caprolactone; a polycarbonate polyol obtained by a reaction of the above-described aliphatic polyol and a carbonate (e.g. a polycarbonate diol obtained by a reaction of 1,6-hexanediol and a diphenylcarbonate); and a polyether polyol (e.g. poly alkylene glycol such as a polyethylene glycol, a polypropylene glycol, a polytetramethylene glycol and the like; preferably poly C1 to C6 alkylene glycol, an ethylene oxide modified bisphenol A and the like); and the like.

The organic polyisocyanate includes, for example, a compound wherein at least 2 isocyanate groups, preferably 2 to 4 isocyanate groups, are linked with a hydrocarbon residue having a carbon number of 1 to 20, preferably C6 to C15, and specifically it includes isophorone diisocyanate, hexamethylene diisocyanate, tolylene diisocyanate, xylene diisocyanate, diphenyl methane-4,4′-diisocyanate, dicyclopentanyl diisocyanate, and the like.

The hydroxy(meth)acrylate compound include, for example, a hydroxy substituted C1 to C15 hydrocarbon(meth)acrylate, preferably a hydroxy substituted C2 to C10 hydrocarbon(meth)acrylate, and specifically it includes hydroxyethyl(meth)acrylate, hydroxypropyl(meth)acrylate, hydroxybutyl(meth)acrylate, dimethylolcyclohexyl mono(meth)acrylate, hydroxycaprolactone(meth)acrylate, and the like.

The urethane(meth)acrylate (E) can be obtained by a reaction as follows. That is, an organic polyisocyanate is mixed with a polyhydric alcohol so that an amount of an isocyanate group is 1.1 to 2.0 equivalents per 1 equivalent of a hydroxyl group, and the reaction is conducted at a reaction temperature of preferably 70 to 90° C. to produce a urethane oligomer. Then a hydroxy(meth)acrylate compound is added so that an amount of a hydroxyl group is preferably 1 to 1.5 equivalents per 1 equivalent of an isocyanate group of the urethane oligomer obtained, and the reaction is conducted preferably at a reaction temperature of 70 to 90° C. to obtain an aimed urethane(meth)acrylate (E).

The urethane(meth)acrylate (E) may be used in an optional proportion of alone or a mixture of at least two sorts thereof. The content of urethane(meth)acrylate (E) is 0 to 50%, 1 to 50% depending on cases, and preferably 0 to 40%, 5 to 40% depending on cases, based on the total weight of the composition according to the present invention. A molecular weight of the urethane(meth)acrylate (E) is preferably 400 to 10,000.

In this connection, in the present invention, a molecular weight means a weight average molecular weight, and a measuring method depends on a light scattering method.

The composition according to the present invention may contain an antioxidant (F), and the antioxidant includes, for example, a hindered phenol compound, an amine compound, a sulfur compound and/or a phosphorus compound, and the like.

Specific examples of the hindered phenol compound as an antioxidant (F) include 2,6-di-tert-butyl-4-methylphenol, 2,2′-methylene-bis(4-methyl-6-tert-butylphenol), 2,2′-methylene-bis(4-ethyl-6-tert-butylphenol), 4,4′-thio-bis(3-methyl-6-tert-butylphenol), 4,4′-butylidene-bis(3-methyl-6-tert-butylphenol), triethylene glycol bis[3-(3-tert-butyl-4-hydroxy-5-methylphenyl)propionate], 1,6-hexanediol bis[3-(3,5-di-tert-butyl-4-hydroxyphenyl)propionate], 2,2-thio-diethylene bis[3-(3,5-di-tert-butyl-4-hydroxyphenyl)propionate], octadecyl 3-[3,5-di-tert-butyl-4-hydroxyphenyl]propionate, 3,5-di-tert-butyl-4-hydroxybenzyl phosphonate-diethyl ester, 1,3,5-trimethyl-2,4,6-tris(3,5-di-tert-butyl-4-hydroxybenzyl)benzene, isooctyl 3-(3,5-di-tert-butyl-4-hydroxyphenyl)propionate, and the like.

Specific examples of the amine compound as an antioxidant (F) include octylated diphenylamine(for example, 4,4′-dioctyl-diphenylamine, and the like), 4,4′-dicumyl-diphenylamine, 6-ethoxy-2,2,4-trimethyl-1,2-dihydroquinoline, 2,2,4-trimethyl-1,2-dihydroquinoline polymer, and the like.

Specific examples of the sulfur compound as an antioxidant (F) include 2-mercaptobenzimidazole, 2,4-bis[(octylthiomethyl)-o-cresol, 2,4-bis-(n-octylthio)-6-(4-hydroxy-3,5-di-tert-butyl anilino)-1,3,5-triazine, and ADKSTAB AO-412S (manufactured by Asahi Denka Co., Ltd.) and the like.

Specific examples of the phosphorus compound as an antioxidant (F) include tris(nonylated phenyl)phosphite, ADKSTAB PER-4C (manufactured by Asahi Denka Co., Ltd.), ADKSTAB 260 (manufactured by Asahi Denka Co., Ltd.), ADKSTAB 522A (manufactured by Asahi Denka Co., Ltd.), and the like.

Among these antioxidant (F), as a particularly preferable one, a hindered phenol compound can be enumerated. One or at least two sorts of these antioxidants can be used. The content of the antioxidant (F) is usually 0 to 10%, 0.005 to 10% depending on cases, and preferably usually 0 to 5%, 0.01 to 5% depending on cases, based on the total weight of the composition according to the present invention.

Further, as other additives, as a polymer to the composition of the present invention, a polyester-, polycarbonate-, polyacrylic-, polyurethane- or polyvinyl-based resin may be added.

Moreover, additives such as an organic solvent, a silane coupling agent, a polymerization inhibitor, a leveling agent, an antistatic agent, a surface lubricant, a fluorescent whitening agent, a light stabilizer (for example, a hindered amine compound, or the like), and a filler may be added. These other additives are contained to an extent of usually 0 to 10%, preferably 0 to 5%.

Preferable examples of the composition according to the present invention includes, based on the total weight of the adhesive composition, the composition which comprises, of 1 to 70%, preferably of 5 to 40%, more preferably of 10 to 40%, of a bisphenol type epoxy(meth)acrylate (A), preferably a bisphenol A type epoxy resin;
5 to 75%, preferably 10 to 70%, more preferably 35 to 65%, of a di(meth)acrylate compound (B) having a cyclic ether structure, preferably a di(meth)acrylate having an alicyclic partial structure having 1 to 4, more preferably 1 to 2, of oxygen atoms, preferably a di(meth)acrylate containing a cyclic ether structure having a ring of 3 to 8 members, more preferably of 5 to 6 members, further preferably a hydroxypivalic aldehyde modified trimethylolpropane di(meth)acrylate; 0.05 to 20%, preferably 1 to 10%, of a photo-polymerization initiator (C); and
a residue of another component.

As the other additives as described above, a (meth)acrylate phosphate compound (D), a urethane(meth)acrylate (E), a (meth)acrylate monomer (B-1) (abbreviated as “other acrylate” depending on cases) excluding the above described (B) component, (D) component, and (E) component, an antioxidant (F), and other additives may be exemplified. Among these, a composition containing a (meth)acrylate phosphate compound (D) and a urethane(meth)acrylate (E) is preferred. Additionally, a composition containing (B-1) component is one of preferable embodiments. Examples of the content of these based on the total weight of the composition according to the present invention are as described below:
A (meth)acrylate phosphate compound (D), preferably a Cl to C3 alkylene oxide modified mono-, di-, or tri(meth)acrylate, more preferably a C1 to C3 alkylene oxide modified di(meth)acrylate phosphate: usually 0 to 5%, 0.005 to 5% depending on cases, and preferably 0 to 3%, 0.05 to 3% depending on cases;
A urethane(meth)acrylate (E) : 0 to 50%, 1 to 50% depending on cases, and preferably 0 to 40%, 5 to 40% depending on cases; and
An other acrylate (B-1) component: 0 to 85% preferably 0 to 60%, more preferably 0 to 40%.

The composition according to the present invention can be obtained by mixing and dissolving each component described above at room temperature to 80° C., and impurities may be removed if necessary by operation such as filtration. The viscosity at 25° C. of the composition according to the present invention is preferably in the range of 100 to 5000 mPa·s (measured by a Brookfield type viscometer) when considering a coating property.

The composition according to the present invention can suitably be used as an adhesive for a bonded optical disk, especially as an adhesive used on bonding optical disk substrates either one or both of which have a total reflection film or a translucent reflection film of silver or a silver alloy. Specifically, the composition is applied on optical disk substrates by any method such as a spin coating method, a 2P method, a roll coating method, and a screen printing method, and two optical disk substrates are bonded so that a film thickness of an adhesive layer becomes 1 to 100 μm after bonding, and then by irradiating with rays such as ultraviolet to near ultraviolet rays (a wave length in the vicinity of 250 to 400 nm) from one or both sides, the adhesive layer is cured to bond the substrates. The irradiation amount is preferably 50 to 1000 mJ/cm², particularly preferably nearly 100 to 700 mJ/cm². For irradiation with ultraviolet to near ultraviolet rays, the light source is not particularly limited so long as it is a lamp which emits ultraviolet to near ultraviolet rays. For example, a low pressure, high pressure or ultra-high pressure mercury lamp, a metal halide lamp, a (pulse) xenon lamp or an electrodeless lamp, or the like may be exemplified.

As an optical disk substrate, those already known, namely those wherein gold is used, or silicon, a silicon compound, silver, a silver alloy, or the like is used, as a translucent reflection film, can be used. Especially, the composition according to the present invention can suitably be used for a bonded optical disk wherein silver or a silver alloy is used as a total reflection film or a translucent reflection film.

In the present invention, a bonded optical disk which is adhered with a cured product of the above-described composition according to the present invention, is contained. Particularly, a bonded optical disk wherein at least one of optical disk substrates has a total reflection film or a translucent reflection film of silver or a silver alloy, and the optical disk substrates are adhered with a cured product of the above-described composition according to the present invention, is contained therein. Said optical disk is used for DVDs, and the like such as DVD−ROM (DVD-5,. DVD-10, DVD-9, DVD-14, and DVD-18), DVD−R, DVD+R, DVD−RW, DVD+RW, DVD-RAM, DVD−R single-sided and double layer manner, DVD+R single-sided and double layer manner, DVD−RW single-sided and double layer manner, DVD+R single-sided and double layer manner, and the like.

### EXAMPLES

Hereinafter the present invention is more specifically explained by way of examples, but the present invention should not in the least be limited by these Examples. In this connection, “part” in Example and Table mean “part by weight” unless noted otherwise.

### Example 1

In a reactor equipped with a stirrer and a thermometer, 30 parts of bisphenol A diglycidylether diacrylate (EPA-37) (A), 60 parts of a hydroxypivalic aldehyde modified trimethylolpropane diacrylate (R-604) (B), 9 parts of 2,2-dimethoxy-1,2-diphenylethan-1-one (IRGACURE 651) (C), 30 parts of dicyclopentadiene oxyethyl acrylate (FA-512A)(B-1), 0.1 part of an ethylene oxide modified dimethacrylate phosphate (PM-2) (D), and 5 parts of a polyether-based urethane acrylate (UA-732) (E), were mixed and dissolved at 60° C. for one hour to prepare a composition according to the present invention. At this time, a viscosity of the composition of the present invention was at 25° C. 500 mPa·s (measured by a Brookfield type viscometer).

A bonded optical disk of a DVD-9 type was prepared by adhering two optical disk substrates using this composition according to the procedures 1 to 4 described below (in accordance with necessity, a substrate wherein a pit for recorded information is formed was used). In the same way, a bonded optical disk of a DVD+R type was prepared by adhering two optical disk substrates using this composition according to the procedures 5 to 8 described below.

1. A silver alloy translucent reflection film substrate (a DVD substrate) was prepared by sputtering (hereinafter described as “sputtering”) a silver alloy (TTP-55A manufactured by Target Technology Company LLC) on a 0.6 mm thick polycarbonate (hereinafter described as “PC”) substrate so as to make an average film thickness of 10 nm.

Further an aluminum alloy total reflection film substrate (a DVD substrate) was prepared by sputtering an aluminum alloy (manufactured by Unaxis) on a 0.6 mm thick PC substrate so as to make an average film thickness of 45 nm.

2. Along the circumference in the total reflection film DVD substrate obtained in the above-described, a circle was drawn with 2.5 g of the adhesive composition (a UV-curable resin composition).

3. The translucent reflection film DVD substrate obtained in the above-described 1 was put on the aluminum alloy substrate (with the sputtering surface upward) so that the sputtering surface of said DVD substrate was downward, and spin-coating was conducted for 4 seconds at a rate of 2000 rpm to bond them so that a film thickness of the resin composition between the silver alloy translucent reflection film and the aluminum alloy may become 45 to 65 μm. An apparatus manufactured by Origin ELECTRIC CO., LTD. was used.

4. By using upper and lower two xenon flash lamps, irradiation of 8 shots at 1800 V was conducted with the upper lamp and irradiation of 4 shots at 1600 V was conducted with the lower lamp. Said disk substrates were adhered by curing of the resin composition and obtained a bonded optical disk of a DVD-9 type. In this connection, the DVD disk was positioned with the silver alloy translucent reflection film on the upper side and the aluminum alloy total reflection film on the lower side.

5. To prepare a bonded optical disk of a DVD+R type, an azo pigment recording layer was formed by a spin-coating method on a 0.6 mm thick PC substrate wherein a pit for DVD+R is formed, and after drying it at 80° C. for 15 min, a silver reflection film substrate was prepared by sputtering silver (manufactured by Unaxis) so as to make an average film thickness of 100 nm.

6. Along the circumference in the silver reflection film substrate, a circle was drawn with 2.5 g of the adhesive composition (a UV-curable resin composition)

7. The 0.6 mm thick PC substrate was put on the silver reflection film substrate obtained in the above-described 6 (with the sputtered surface upward), and spin-coating was conducted for 4 seconds at a rate of 3000 rpm to bond them so that a film thickness of the resin composition between the PC substrate and the silver reflection film may become 35 to 55 μm. An apparatus manufactured by Origin ELECTRIC CO., LTD. was used.

8. By using a xenon flash lamp, irradiation of 8 shots at 1800 V was conducted from the upper side. Said disk substrates were adhered by curing of composition and obtained a bonded optical disk of a DVD+R type. In this connection, the DVD disk was positioned with the PC substrate on the upper side and the silver reflection film substrate on the lower side.

9. On the DVD+R substrates prepared according to the above-described 5 to 8, a signal of about 4.7 gigabytes was recorded at a writing speed of 8 times rate by a drive (Type:PX-708A) manufactured by PLEXSTAR Inc.

### Example 2

The composition according to the present invention in Table 1 was prepared in the same way as Example 1 except that 30 parts of bisphenol A diglycidylether diacrylate (EPA-37) (A), 60 parts of a hydroxypivalic aldehyde modified trimethylolpropane diacrylate (R-604) (B), 9 parts of 1-hydroxycyclohexyl phenyl ketone (IRGACURE 184) (C), 30 parts of dicyclopentadiene oxyethyl acrylate (FA-512A) (B-1), 0.1 part of an ethylene oxide modified dimethacrylate phosphate (PM-2) (D), and 5 parts of a polyether-based urethane acrylate (UA-732) (E) were used, and subsequently a bonded optical disk was prepared in the same way as Example 1.

### Example 3

The composition according to the present invention in Table 1 was prepared in the same way as Example 1 except that 10 parts of bisphenol A diglycidylether diacrylate (EPA-37) (A), 50 parts of a hydroxypivalic aldehyde modified trimethylolpropane diacrylate (R-604) (B), 7 parts of 2,2-dimethoxy-1,2-diphenylethan-1-one (IRGACURE 651) (C), 0.1 part of an ethylene oxide modified dimethacrylate phosphate (PM-2) (D), 10 parts of tris(acryloxyethyl)isocyanurate (M-315) (B-1), 10 parts of an EO (ethylene oxide) modified bisphenol A diacrylate (R-551), and 5 parts of a polyether-based urethane acrylate (UA-732) (E) were used, and subsequently a bonded optical disk was prepared in the same way as Example 1.

### Example 4

The composition according to the present invention in Table 1 was prepared in the same way as Example 1 except that 30 parts of bisphenol A diglycidylether diacrylate (EPA-37) (A), 60 parts of a hydroxypivalic aldehyde modified trimethylolpropane diacrylate (R-604) (B), 9 parts of 2-benzyl-2-dimethylamino-1-(4-morpholinophenyl)-butane-1-one (IRGACURE 907) (C), 0.1 part of an ethylene oxide modified dimethacrylate phosphate (PM-2) (D), and 5 parts of a polyether-based urethane acrylate (UA-732) (E) were used, and subsequently a bonded optical disk was prepared in the same way as Example 1.

### Comparative Example 1

The composition for Comparative Example, which does not contain a di(meth)acrylate compound (B) having a cyclic ether structure and contains a (meth)acrylate compound having an alicyclic structure (tricyclodecanedimethylol diacrylate: R-684) in Table 1, was prepared in almost the same way as Example 1 except that 30 parts of bisphenol A diglycidylether diacrylate (EPA-37) (A), 9 parts of 1-hydroxycyclohexyl phenyl ketone (IRGACURE 184) (C), 30 parts of dicyclopentadiene oxyethyl acrylate (FA-512A)(B-1), 0.1 part of an ethylene oxide modified dimethacrylate phosphate (PM-2) (D), and 60 parts of tricyclodecanedimethylol diacrylate (R-684) were used, and subsequently a bonded optical disk was prepared in the same way as Example 1.

TABLE 1

| | Example | | | | Comp. Ex. |
|---|---|---|---|---|---|
| | 1 | 2 | 3 | 4 | 1 |
| EPA-37 | 30 | 30 | 10 | 30 | 30 |
| R-604 | 60 | 60 | 50 | 60 | |
| IRGACURE 651 | 9 | | 7 | | |
| IRGACURE 184 | | 9 | | | 9 |
| IRGACURE 907 | | | | 9 | |
| FA-512A | 30 | 30 | | | 30 |
| PM-2 | 0.1 | 0.1 | 0.1 | 0.1 | 0.1 |
| M-315 | | | 10 | | |
| R-684 | | | | | 60 |
| R-551 | | | 10 | | |
| UA-732 | 5 | 5 | 5 | 5 | |
| Viscosity | 500 | 490 | 530 | 520 | |
| (mPa · s, 25° C.) | | | | | |

In this connection, each composition abbreviated in Table 1 is as follows. And a number showing a composition in Table 1 represents part by weight. EPA-37: bisphenol A diglycidyl ether diacrylate manufactured by NIPPON KAYAKU CO., LTD., R-604: a hydroxypivalic aldehyde modified trimethylolpropane diacrylate manufactured by NIPPON KAYAKU CO., LTD, IRGACURE 651: 2,2-dimethoxy-1,2-diphenylethan-1-one manufactured by Ciba Specialty Chemicals, IRGACURE 184: 1-hydroxycyclohexyl phenyl ketone manufactured by Ciba Specialty Chemicals, IRGACURE 907: 2-benzyl-2-dimethylamino-1-(4-morpholinophenyl)-butane-1-one manufactured by Ciba Specialty Chemicals, FA-512A: dicyclopentadiene oxyethyl acrylate manufactured by Hitachi Chemical Co., Ltd., PM-2:an ethylene oxide modified dimethacrylate phosphate manufactured by NIPPON KAYAKU CO., LTD., M-315: tris(acryloxyethyl)isocyanurate manufactured by TOAGOSEI Co., Ltd., R-684: tricyclodecanedimethylol diacrylate manufactured by NIPPON KAYAKU CO., LTD. R-551: an EO (ethylene oxide) modified bisphenol A diacrylate manufactured by NIPPON KAYAKU CO., LTD. UA-732: a polyether-based urethane acrylate manufactured by NIPPON KAYAKU CO., LTD.

### Testing Examples

Bonded optical disks obtained in Examples or Comparative Examples were evaluated according to the following method.

1. Appearance of a Reflection Film Before and After Durability Test (Common to DVD-9 and DVD+R)

A bonded optical disk obtained was left in an environment of 80° C. and 85% RH (relative humidity) for 500 hours and 700 hours. A state of a reflection film was visually observed. The observation results were assessed as follows and shown in Table 2:
G: Compared to those immediately after adhesion, no change was observed in the total reflection film or the translucent reflection film in the evaluation after 700 hours;
M: Compared to those immediately after adhesion, no change was observed in the total reflection film or the translucent reflection film in the evaluation after 500 hours, but considerable discoloration or pinholes were found in the total reflection film and the translucent reflection film in the evaluation after 700 hours; and
P: Compared to those immediately after adhesion, considerable discoloration or pinholes were found in the total reflection film and the translucent reflection film in the evaluation after 500 hours.
   2. Electric Signal of an Optical Disk Before and After Durability Test
   DVD-9:

A bonded optical disk obtained was left in an environment of 80° C. and 85% RH for 700 hours. The electric signal of the bonded optical disk after the durability test was evaluated using a DVD data signal measuring device DVD-2000 manufactured by AECO, Ltd.

“System jitter” and “PI error” are one of electric signals from an optical disk, and the larger the value, the more deteriorated the data of the bonded optical disk is shown:
G: system jitter of not more than 8.0 and PI error of not more than 250;
M: system jitter of 8.1 to 9.0 and PI error of 251 to 350; and
P: system jitter of not less than 9.1 and PI error of not less than 351.
   DVD+R:

A bonded optical disk obtained was left in an environment of 80° C. and 85% RH for 480 hours. The electric signal of the bonded optical disk after the durability test was evaluated using a DVD data signal measuring device DVD-CATS SA-300 manufactured by AudioDeb AB.

“Tilt jitter” and “PISum8” are one of electric signals from an optical disk, and the larger the value, the more deteriorated the data of the bonded optical disk is shown:
G: tilt jitter of not more than 8.0 and PISum8 of not more than 250;
M: tilt jitter of 8.1 to 9.0 and PISum8 of 251 to 350; and
P: tilt jitter of not less than 9.1 and PISum8 of not less than 351.
   3. Evaluation of Adhesion with a Reflection Film DVD-9:

Adhesion strength with an adhesive between a reflection film and an optical disk substrate of a bonded optical disk obtained was evaluated. The evaluation was conducted as follows. At a bonded interfacial part of the bonded optical disk obtained, a small notch of about 5 mm depth was made with a cutter, the bonded optical disk was peeled with a finger from the notch, and a state of the reflection film after the peeling was observed:
G: adhesion is excellent, and on peeling, not less than half of a translucent reflection film or a total reflection film was peeled from a polycarbonate substrate;
M: adhesion is insufficient, and on peeling, only a portion of a translucent reflection film or a total reflection film was peeled from a polycarbonate substrate; and
P: adhesion is weak, and on peeling, almost all of a reflection film was not peeled from a polycarbonate substrate.
   DVD+R:

Adhesion strength with an adhesive between a reflection film and an optical disk substrate of a bonded optical disk obtained was evaluated. The evaluation was conducted as follows. At a bonded interfacial part of the bonded optical disk obtained, a small notch of about 5 mm depth was made with a cutter, the bonded optical disk was peeled with a finger from the notch, and a state of the reflection film after the peeling was observed:
G: adhesion is excellent, and on peeling, not less than half of a total reflection film was peeled from an interface with a pigment layer;
M: adhesion is insufficient, and on peeling, only a portion of a total reflection film was peeled from an interface with a pigment layer; and
P: adhesion is weak, and almost all of a reflection film was not peeled from an interface with a pigment layer.

The evaluation result with DVD-9 is described in Table 2.

TABLE 2

| | Example | | | | Comp. Ex. |
|---|---|---|---|---|---|
| | 1 | 2 | 3 | 4 | 1 |
| 1. Appearance of a | G | G | G | G | G |
| reflection film before | | | | | |
| and after durability test | | | | | |
| 2. Electric signal of an | G | G | G | G | G |
| optical disk before and | | | | | |
| after durability test | | | | | |
| 3. Evaluation of adhesion | G | G | G | G | P |
| with a reflection film | | | | | |

The evaluation result with DVD+R is described in Table. 3.

TABLE 3

| | Example | | | | Comp. Ex. |
|---|---|---|---|---|---|
| | 1 | 2 | 3 | 4 | 1 |
| 1. Appearance of a | G | G | G | G | G |
| reflection film before | | | | | |
| and after durability test | | | | | |
| 2. Electric signal of an | G | G | G | G | G |
| optical disk before and | | | | | |
| after durability test | | | | | |
| 3. Evaluation of adhesion | G | G | G | G | P |
| with a reflection film | | | | | |

The results of Table 2 and Table 3 exhibit that an optical disk adhered by using the composition according to the present invention containing a di(meth)acrylate compound having a cyclic ether structure, has particularly excellent adhesion between a reflection film and a UV cured product.

### INDUSTRIAL APPLICABILITY

By adhering optical disk substrates using a composition (a UV-curable resin composition) according to the present invention, in a bonded optical disk using a translucent reflection film or a total reflection film of silver or a silver alloy, high durability equivalent to those of conventional bonded optical disks in which gold is used for a translucent reflection film, can be obtained and further high adhesion strength between a translucent reflection film or a total reflection film and an adhesive cured product can be obtained. Moreover, among blank DVDs such as DVD−R, DVD+R, DVD−RW, DVD+RW, DVD-RAM, and the like, in blank DVDs wherein silver or a silver alloy is used as a reflection film, high durability equivalent to that on use of a protective coat can be obtained, and further high adhesion strength between a metallic reflection film and an adhesive cured product, and a polycarbonate substrate and an adhesive cured product, can be obtained. Due to high adhesion strength, even by repeating use of DVDs, a bonded optical disk cannot be peeled.

1. An adhesive composition comprising a bisphenol type epoxy(meth)acrylate (A), a di(meth)acrylate compound (B) having a cyclic ether structure, and a photo-polymerization initiator (C).

2. The adhesive composition according to claim 1, which further comprises a (meth)acrylate phosphate compound (D).

3. The adhesive composition according to claim 1, which further comprises a urethane(meth)acrylate (E)

4. The adhesive composition according to claim 1, which comprises a bisphenol type epoxy(meth)acrylate (A), a di(meth)acrylate compound (B) having a cyclic ether structure, a photo-polymerization initiator (C), a (meth)acrylate phosphate compound (D), and a urethane(meth)acrylate (E).

5. The adhesive composition according to claim 1, which comprises, in terms of % by weight based on the total of the adhesive composition, 1 to 70% of a bisphenol type epoxy(meth)acrylate (A), 5 to 75% of a di(meth)acrylate compound (B) having a cyclic ether structure, 0.05 to 20% of a photo-polymerization initiator (C), and a residue of another component.

6. The adhesive composition according to claim 1, wherein the di(meth)acrylate compound (B) having a cyclic ether structure is a hydroxy-substituted (C4 to C10) tertiary aldehyde modified trimethylolpropane di(meth)acrylate or a modified product thereof.

7. The adhesive composition according to claim 6, wherein the di(meth)acrylate compound (B) having a cyclic ether structure is a hydroxypivalic aldehyde modified trimethylolpropane di(meth)acrylate.

8. A bonded optical disk, wherein two optical disk substrates are adhered with a cured product of an adhesive composition according to anyone of claims 1 to 7.

9. The bonded optical disk according to claim 8, wherein at least one of the optical disk substrates is an optical disk substrate having a total reflection film or a translucent reflection film comprising silver or a silver alloy.
